(19) United States
(12) Patent Application Publication
(10) Pub. No.: US 2016/0307284 A1
(43) Pub. Date: Oct. 20, 2016

(54) METHODS AND SYSTEMS RELATING TO CONTEXTUAL INFORMATION AGGREGATION AND DISSEMINATION

(71) Applicant: nTEROP CORPORATION, KANATA (CA)

(72) Inventor: JORDAN PARSONS, OTTAWA (CA)

(21) Appl. No.: 15/098,847

(22) Filed: Apr. 14, 2016

Related U.S. Application Data
(60) Provisional application No. 62/147,067, filed on Apr. 14, 2015.

(51) Int. Cl. G06Q 50/26; G06Q 10/10; G06F 17/30; H04L 12/58

(52) U.S. Cl. CPC G06Q 50/26; H04L 51/32; G06Q 10/1097; G06F 17/3087

(57) ABSTRACT

Today a law enforcement officer can retrieve, provide, act upon, and collaborate on existing information in real time or near real time with other officers locally, nationally and internationally. However, the increased access to and ability to create information can lead them becoming saturated and/or absorbed in the information and their effectiveness impacted. Correspondingly, providing information to and receiving information from the officer can negatively impact the operation of the overall organization that the deployed officer is part of. Critical information they provide can be lost, delayed or filtered to lower priority by disjointed systems where with many legacy systems the dominant mode of data entry has been manual. Accordingly, it would be beneficial for the officers to contextually access salient information that they want based upon their context and environment and for officers to be provided with ranked and prioritized investigative responses, duties, or cases.

### CROSS-REFERENCE TO RELATED APPLICATIONS

This patent application claims the benefit of priority from U.S. Provisional Patent Application 62/147,067 filed Apr. 14, 2015 entitled “Methods and Systems relating to Contextual Information Aggregation and Dissemination”, the entire contents of which are incorporated herein by reference.

### FIELD OF THE INVENTION

The present invention relates to relevant information sharing, context management and more particularly to relevant information sharing solutions for law enforcement, security services, emergency services, military organizations and other distributed organizations.

### BACKGROUND OF THE INVENTION

Within a variety of organizations such as law enforcement, security services, emergency services, and the military whilst these have well defined high level strategic objectives their day to day operations require consistent dissemination of information so that all members of the organization are aware of those elements of information that impact them directly personally or at their team level(s). This information can range from actionable priorities through to situational awareness, requests for information, information distribution, and “be on the look outs” (BOLOs). At the same time these organizations are typically financially accountable and result accountable to one or more levels of political hierarchy such that their performance and costs are not only known and quantified but viewed against targets and subject to periodic justification/review.

Considering a law enforcement officer their role has evolved from the traditional officer on their defined beats with detailed knowledge of their patch's businesses, residents, etc. to an officer covering a large region of a municipality, urban, or rural landscape with less direct interaction. At the same time as their budgets and personnel are adjusted to the varying population etc. technology has increasingly become an important part of seeking means to increase the effectiveness of each individual law enforcement officer and just as with manufacturing businesses achieve more with less. Accordingly, the law enforcement officer has gone from isolated fixed reporting locations, e.g. police stations or dedicated wired telephone locations, through mobile radios to today's officer who carries a highly functionalized portable radio, carries a smartphone, and can access a dedicated computer terminal within their patrol vehicle.

Accordingly, today's officer can retrieve, provide, act upon, and collaborate on existing information in real time or near real time. However, with the increased access to and ability to create information they like many may become saturated and/or absorbed in the information and their effectiveness impacted. Correspondingly, providing the information to and receiving the information from the officer can negatively impact the operation of the overall organization that the deployed officer is part of. Critical information they provide can be lost, delayed or filtered to lower priority by disjointed systems where with many legacy systems the dominant mode of data entry has been manual. Equally, important and critical information to the user can be similarly lost, delayed, or filtered to low priority.

It would therefore be beneficial for such organizations to be able to capture and manage analyst reports so that information is prioritized according to the deployed officer's context and environment. It would be beneficial for the officers to contextually access salient information that they want based upon their context and environment and for officers to be provided with ranked and prioritized investigative responses, duties, or cases. At the same time, it would be beneficial for such interfaces to the officer in the field to be integrated with systems providing improved internal communications and consistency with information the officers are provided with or provide during briefing sessions etc. Accordingly, it would be beneficial to provide these organizations with a platform supporting all of these initiatives whilst providing improved data quality, enhanced information sharing within the organization and with partner organizations, and yet without flooding the members of the organization with irrelevant data or data with different time sensitivities jumbled together.

Accordingly, embodiments of the invention beneficially provide solutions to these conflicting requirements through a combination of standardised reporting interfaces and a core relevancy engine that processes data based upon not only the officer's context and environment but their assigned tasks, duties, and ability to consume new data or revised data. Further, through processing the data through standardised reporting interfaces information flow and capture are improved whilst its quality is not degraded through the communications chain. Hence, analysts are able to capture the output of their crime analysis efforts confident that the key intelligence products will targeted at the proper region, division, or officers whilst being easily shared internally or exported and shared with partner organizations or agencies. Beneficially, the core relevancy engine by taking context and environment into consideration may therefore simplify key functions of a supervising officer. It would be beneficial to replace today's clipboard of faxed images or printed emails with an automatically generated slideshow of information that the supervising officer has prioritized for his or her specific shift by adjusting the ranking and prioritization of information for the daily shift briefing performed automatically by the software platform. This daily shift briefing can then be automatically provided to the supervising officers based upon their allocated zones etc. or pulled subsequently by them. Through real time data management, it would be beneficial for such briefings to include priority warrants with optionally bail or penitentiary release conditions allowing officers to be aware of actions relating to known individuals encountered during their shift, etc.

It would be further beneficial for the software platform through its context and environment aware knowledge of the officers to provide updated information on active issues or alert the officer to a new issue or an issue that they can address. Hence, an officer can be alerted to a recent warrant when they are in the vicinity of the address associated with the warrant enabling them to act on it but only if their current context and environment allow for such. Providing that information whilst the user is currently executing a search on a premises in relation to another warrant or member of public call is not beneficial.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating to relevant information sharing, context management and more particularly to relevant information sharing solutions for law enforcement, security services, emergency services, military organizations and other distributed organizations.

In accordance with an embodiment of the invention there is provided a method of managing content provided to a user, who is a member of a structured organization, in dependence upon the context of the user with respect to the activities and responsibilities of the structured organization.

In accordance with an embodiment of the invention there is provided a method of generating a briefing for presentation to a predetermined subset of the members of a structured organization, the briefing generated automatically based upon contextual information relating to the predetermined subset of the members of a structured organization.

In accordance with an embodiment of the invention there is provided a method of managing content provided to a user, who is a member of a structured organization, in dependence upon establishing that the current context of the user with respect to the activities and responsibilities of the structured organization has changed such that new content should be provided to the user.

In accordance with an embodiment of the invention there is provided a method of managing content provided to a user, who is a member of a structured organization, in dependence upon establishing that the information provided to the user relating to a current context of the user with respect to the activities and responsibilities of the structured organization should change such that new content should be provided to the user, the need for change being established in dependence upon a variation within remotely stored data used to generate the content provided to the user based upon a current context.

In accordance with an embodiment of the invention there is provided a relevance engine connected to a globally distributed network for managing content provided to a user, who is a member of a structured organization, in dependence upon the context of the user with respect to the activities and responsibilities of the structured organization, wherein
the relevance engine via the globally distributed network is connected to at least one of:
a mobile module providing the managed content to the user;
a geointelligence module accessing stored items and reports relating to items in conjunction with attributes associated with the items and reports relating to items;
third party databases storing information relating to physical assets and/or individuals; and
a geobriefing module for generating a briefing for presentation to a predetermined subset of the members of a structured organization which was generated automatically based upon contextual information relating to the predetermined subset of the members of a structured organization.

In accordance with an embodiment of the invention there is provided a system as described with respect to at least one of the specification and/or figures.

In accordance with an embodiment of the invention there is provided a method as described with respect to at least one of the specification and/or figures.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a typical hierarchy for an organization exploiting embodiments of the invention;

FIG. 2 depicts a network environment within which embodiments of the invention may be employed;

FIG. 3 depicts a wireless portable electronic device supporting communications to a network such as depicted in FIG. 2 and as supporting embodiments of the invention; and

FIGS. 4A and 4B depict schematically software platforms supporting embodiments of the invention as a framework of modules with exemplary interconnections;

FIG. 5 depicts schematically in hierarchal form a software platform supporting embodiments of the invention as a framework of modules with exemplary interconnections;

FIG. 6 depicts an exemplary flow for information within a software platform supporting embodiments of the invention;

FIG. 7 depicts a geo-mapping feature within a software platform supporting embodiments of the invention for assigning a primary zone for a law enforcement officer;

FIG. 8 depicts exemplary map overlay images for a software platform supporting embodiments of the invention;

FIG. 9 depicts device context aware incident presentation to a law enforcement officer according to a software platform supporting embodiments of the invention;

FIG. 10 depicts secondary information screens relating to specific incidents selected by a law enforcement officer within a software platform supporting embodiments of the invention;

FIG. 11 depicts a briefing structure for a supervisory officer automatically generated for them by a software platform supporting embodiments of the invention;

FIG. 12 depicts exemplary user interfaces upon a law enforcement officer's portable electronic device as provided by a software platform supporting embodiments of the invention;

FIG. 13 depicts an exemplary permissions interface for a software platform supporting embodiments of the invention; and

FIG. 14 depicts standardized reports generated from a software platform supporting embodiments of the invention.

### DETAILED DESCRIPTION

The present invention is directed to relevant information sharing, context management and more particularly to relevant information sharing solutions for law enforcement, security services, emergency services, military organizations and other distributed organizations.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, a wearable device, a portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a slot machine, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals whose biometric data may be, but not limited to, monitored, acquired, stored, transmitted, processed and analysed either locally or remotely to the user wherein by their engagement with a service provider, third party provider, enterprise, social network, social media etc. via a dashboard, web service, website, software plug-in, software application, graphical user interface acquires, for example, electronic content. This includes, but is not limited to, private individuals, employees of organizations and/or enterprises, members of community organizations, members of charity organizations, men, women, children, teenagers, and animals. In its broadest sense the user may further include, but not be limited to, software systems, mechanical systems, robotic systems, android systems, etc. that may be characterised by an ability to receive data, process said data to make a decision, and generate an output in respect of said decision. Such systems may simulate human aspects such as vision for data input and motion for decision output or may be purely electronic in these input/output conditions.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

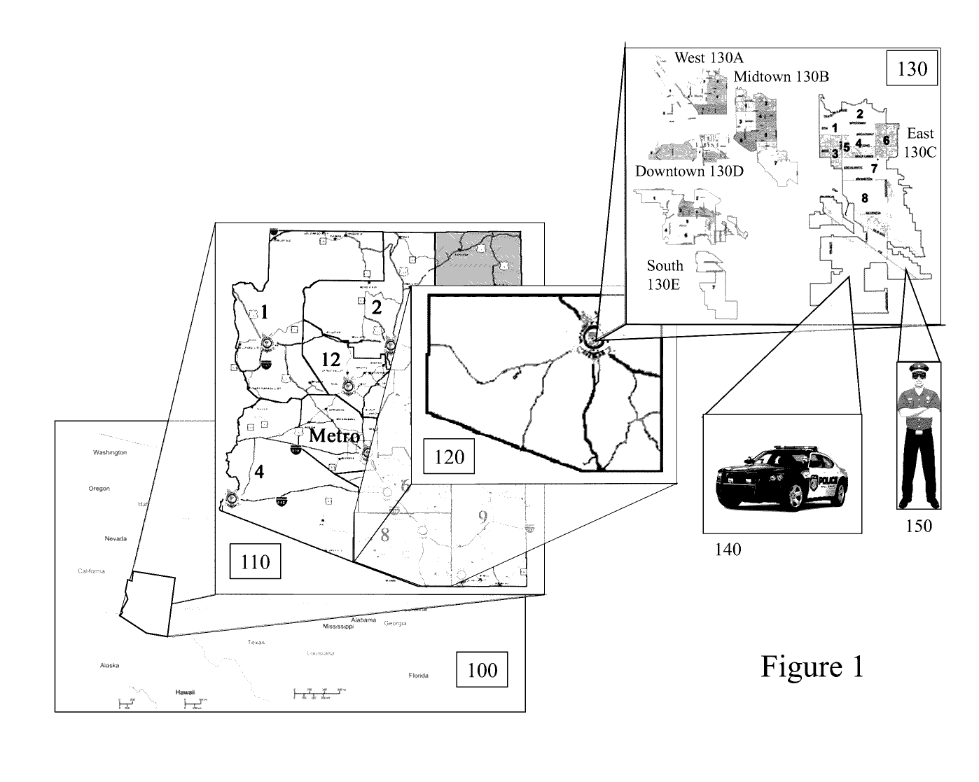

Now referring to FIG. 1 there is depicted a typical hierarchy for an organization exploiting embodiments of the invention for a law enforcement officer (officer) 150. In this instance the officer 150 is within the United States 100 who is employed by the Tucson Police Department in Tucson, Ariz. Accordingly, at the point in time depicted the officer 150 is assigned to Sector 8 within the Operations Division East 130C which together with the remaining Operations Divisions West 130A, Midtown 130B, Downtown 130D, and South 130E provide law enforcement for Tucson. Tucson is within District 8 120 of the Arizona Highway Patrol under the direction of Arizona Department of Public Safety for the State of Arizona 110. Associated with the officer 150 within their day to day operations within the Tucson Police Department is cruiser 140. Accordingly, the officer 150 whilst working within one or more designated zones (not depicted for clarity) within their sector. Sector 8, of the Operations Division East 130C may require information relating to activities within their sector, but may also be provided with information relating to their Division overall as well as issues affecting all Divisions within the Tucson Police Department. Additionally, pertinent information relating to their activities may be sourced externally from their Sector, Division, and Police Department as a result of activities, intelligence, etc. within District 8 of the Arizona Highway Patrol as well as other Districts within Arizona and from other law enforcement departments and resources within the United States 100.

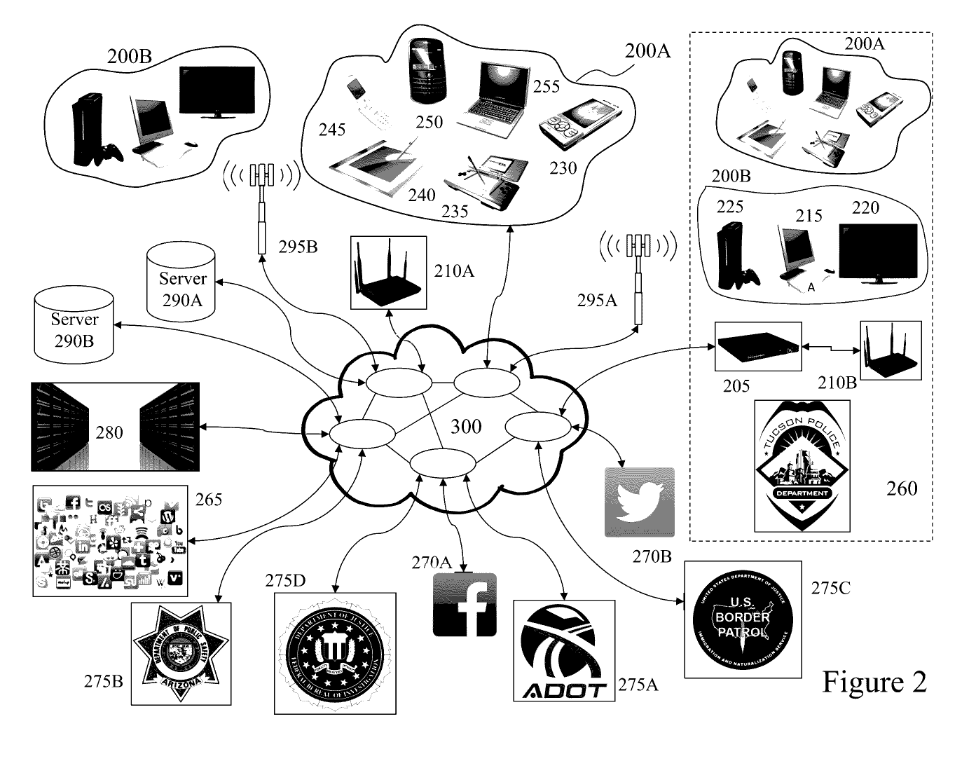

Referring to FIG. 2 there is depicted a network environment 200 within which embodiments of the invention may be employed supporting law enforcement systems and law enforcement applications/platforms (LESLEAPs) according to embodiments of the invention. Such LESLEAPs, for example supporting multiple channels and dynamic content. As shown first and second user groups 200A and 200B respectively interface to a telecommunications network 200. Within the representative telecommunication architecture, a remote central exchange 280 communicates with the remainder of a telecommunication service providers network via the network 200 which may include for example long-haul OC-48/OC-192 backbone elements, an OC-48 wide area network (WAN), a Passive Optical Network, and a Wireless Link. The central exchange 280 is connected via the network 200 to local, regional, and international exchanges (not shown for clarity) and therein through network 200 to first and second cellular APs 295A and 295B respectively which provide Wi-Fi cells for first and second user groups 200A and 200B respectively. Also connected to the network 200 are first and second Wi-Fi nodes 210A and 210B, the latter of which being coupled to network 200 via router 205. Second Wi-Fi node 210B is associated with Enterprise 260, e.g. Tucson Police Department, within which there are other first and second user groups 200A and 200B. Second user group 200B may also be connected to the network 200 via wired interfaces including, but not limited to, DSL, Dial-Up, DOCSIS, Ethernet, G.hn, ISDN, MoCA, PON, and Power line communication (PLC) which may or may not be routed through a router such as router 205.

Within the cell associated with first AP 210A the first group of users 200A may employ a variety of PEDs including for example, laptop computer 255, portable gaming console 235, tablet computer 240, smartphone 250, cellular telephone 245 as well as portable multimedia player 230. Within the cell associated with second AP 210B are the second group of users 200B which may employ a variety of FEDs including for example gaming console 225, personal computer 215 and wireless/Internet enabled television 220 as well as cable modem 205. First and second cellular APs 295A and 295B respectively provide, for example, cellular GSM (Global System for Mobile Communications) telephony services as well as 3G and 4G evolved services with enhanced data transport support. Second cellular AP 295B provides coverage in the exemplary embodiment to first and second user groups 200A and 200B. Alternatively the first and second user groups 200A and 200B may be geographically disparate and access the network 200 through multiple APs, not shown for clarity, distributed geographically by the network operator or operators. First cellular AP 295A as show provides coverage to first user group 200A and environment 270, which comprises second user group 200B as well as first user group 200A. Accordingly, the first and second user groups 200A and 200B may according to their particular communications interfaces communicate to the network 200 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 200A may form associations either through standards such as IEEE 802.15 and Bluetooth as well in an ad-hoc manner.

Also connected to the network 200 are Social Networks (SOCNETS) 265, first and second social networks 270A and 270B respectively, e.g. Facebook™ and Twitter™ respectively; first and second state agencies 275A and 275B respectively, e.g. Arizona Department of Public Safety and Arizona Department of Transport, first and second associated agencies 275C and 275D respectively, e.g. U.S. Border Patrol and Federal Bureau of Investigation, and, as well as first and second servers 290A and 290B which together with others, not shown for clarity. First and second servers 290A and 290B may host according to embodiments of the inventions multiple services associated with a provider of publishing systems and publishing applications/platforms (LESLEAPs); a provider of a SOCNET or Social Media (SOME) exploiting LESLEAP features; a provider of a SOCNET and/or SOME not exploiting LESLEAP features; a provider of services to PEDS and/or FEDS; a provider of one or more aspects of wired and/or wireless communications; an Enterprise 260 exploiting LESLEAP features; license databases; content databases; image databases; content libraries; customer databases; websites; and software applications for download to or access by FEDs and/or PEDs exploiting and/or hosting LESLEAP features. First and second primary content servers 290A and 290B may also host for example other Internet services such as a search engine, financial services, third party applications and other Internet based services.

Accordingly, a consumer and/or customer (CONCUS) may exploit a PED and/or FED within an Enterprise 260, for example, and access one of the first or second primary content servers 290A and 290B respectively to perform an operation such as accessing/downloading an application which provides LESLEAP features according to embodiments of the invention; execute an application already installed providing LESLEAP features; execute a web based application providing LESLEAP features; or access content. Similarly, a CONCUS may undertake such actions or others exploiting embodiments of the invention exploiting a PED or FED within first and second user groups 200A and 200B respectively via one of first and second cellular APs 295A and 295B respectively and first Wi-Fi nodes 210A.

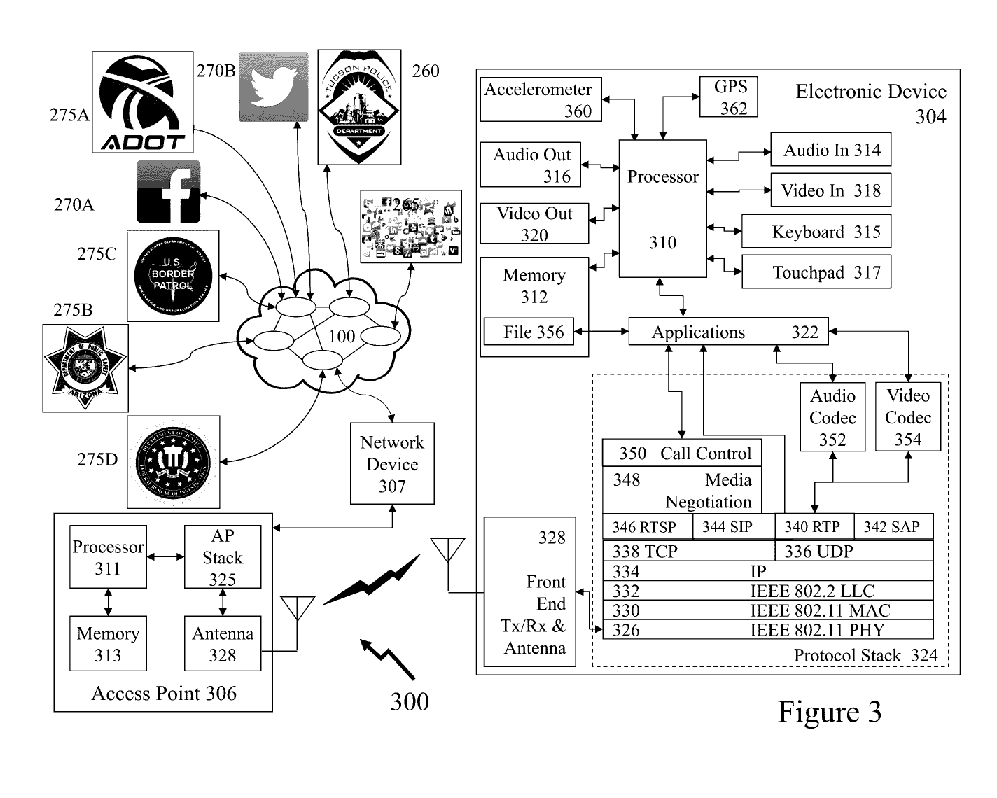

Now referring to FIG. 3 there is depicted an electronic device 304 and network access point 307 supporting LESLEAP features according to embodiments of the invention. Electronic device 304 may, for example, be a PED and/or FED and may include additional elements above and beyond those described and depicted. Also depicted within the electronic device 304 is the protocol architecture as part of a simplified functional diagram of a system 300 that includes an electronic device 304, such as a smartphone 255, an access point (AP) 306, such as first AP 210, and one or more network devices 307, such as communication servers, streaming media servers, and routers for example such as first and second servers 290A and 290B respectively. Network devices 307 may be coupled to AP 306 via any combination of networks, wired, wireless and/or optical communication links such as discussed above in respect of FIG. 2 as well as directly as indicated. Network devices 307 are coupled to network 200 and therein Social Networks (SOCNETS) 265, first and second social networks 270A and 270B respectively, e.g. Facebook™ and Twitter™ respectively; first and second state agencies 275A and 275B respectively, e.g. Arizona Department of Public Safety and Arizona Department of Transport, first and second associated agencies 275C and 275D respectively, e.g. U.S. Border Patrol and Federal Bureau of Investigation.

The electronic device 304 includes one or more processors 310 and a memory 312 coupled to processor(s) 310. AP 306 also includes one or more processors 311 and a memory 313 coupled to processor(s) 310. A non-exhaustive list of examples for any of processors 310 and 311 includes a central processing unit (CPU), a digital signal processor (DSP), a reduced instruction set computer (RISC), a complex instruction set computer (CISC) and the like. Furthermore, any of processors 310 and 311 may be part of application specific integrated circuits (ASICs) or may be a part of application specific standard products (ASSPs). A non-exhaustive list of examples for memories 312 and 313 includes any combination of the following semiconductor devices such as registers, latches, ROM, EEPROM, flash memory devices, nonvolatile random access memory devices (NVRAM), SDRAM, DRAM, double data rate (DDR) memory devices, SRAM, universal serial bus (USB) removable memory, and the like.

Electronic device 304 may include an audio input element 314, for example a microphone, and an audio output element 316, for example, a speaker, coupled to any of processors 310. Electronic device 304 may include a video input element 318, for example, a video camera or camera, and a video output element 320, for example an LCD display, coupled to any of processors 310. Electronic device 304 also includes a keyboard 315 and touchpad 317 which may for example be a physical keyboard and touchpad allowing the user to enter content or select functions within one of more applications 322. Alternatively, the keyboard 315 and touchpad 317 may be predetermined regions of a touch sensitive element forming part of the display within the electronic device 304. The one or more applications 322 that are typically stored in memory 312 and are executable by any combination of processors 310. Electronic device 304 also includes accelerometer 360 providing three-dimensional motion input to the process 310 and GPS 362 which provides geographical location information to processor 310.

Electronic device 304 includes a protocol stack 324 and AP 306 includes a communication stack 325. Within system 300 protocol stack 324 is shown as IEEE 802.11 protocol stack but alternatively may exploit other protocol stacks such as an Internet Engineering Task Force (IETF) multimedia protocol stack for example. Likewise, AP stack 325 exploits a protocol stack but is not expanded for clarity. Elements of protocol stack 324 and AP stack 325 may be implemented in any combination of software, firmware and/or hardware. Protocol stack 324 includes an IEEE 802.11-compatible PHY module 326 that is coupled to one or more Front-End Tx/Rx & Antenna 328, an IEEE 802.11-compatible MAC module 330 coupled to an IEEE 802.2-compatible LLC module 332. Protocol stack 324 includes a network layer IP module 334, a transport layer User Datagram Protocol (UDP) module 336 and a transport layer Transmission Control Protocol (TCP) module 338.

Protocol stack 324 also includes a session layer Real Time Transport Protocol (RTP) module 340, a Session Announcement Protocol (SAP) module 342, a Session Initiation Protocol (SIP) module 344 and a Real Time Streaming Protocol (RTSP) module 346. Protocol stack 324 includes a presentation layer media negotiation module 348, a call control module 350, one or more audio codecs 352 and one or more video codecs 354. Applications 322 may be able to create maintain and/or terminate communication sessions with any of devices 307 by way of AP 306. Typically, applications 322 may activate any of the SAP, SIP, RTSP, media negotiation and call control modules for that purpose. Typically, information may propagate from the SAP, SIP, RTSP, media negotiation and call control modules to PHY module 326 through TCP module 338, IP module 334, LLC module 332 and MAC module 330.

It would be apparent to one skilled in the art that elements of the electronic device 304 may also be implemented within the AP 306 including but not limited to one or more elements of the protocol stack 324, including for example an IEEE 802.11-compatible PHY module, an IEEE 802.11-compatible MAC module, and an IEEE 802.2-compatible LLC module 332. The AP 306 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 304 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

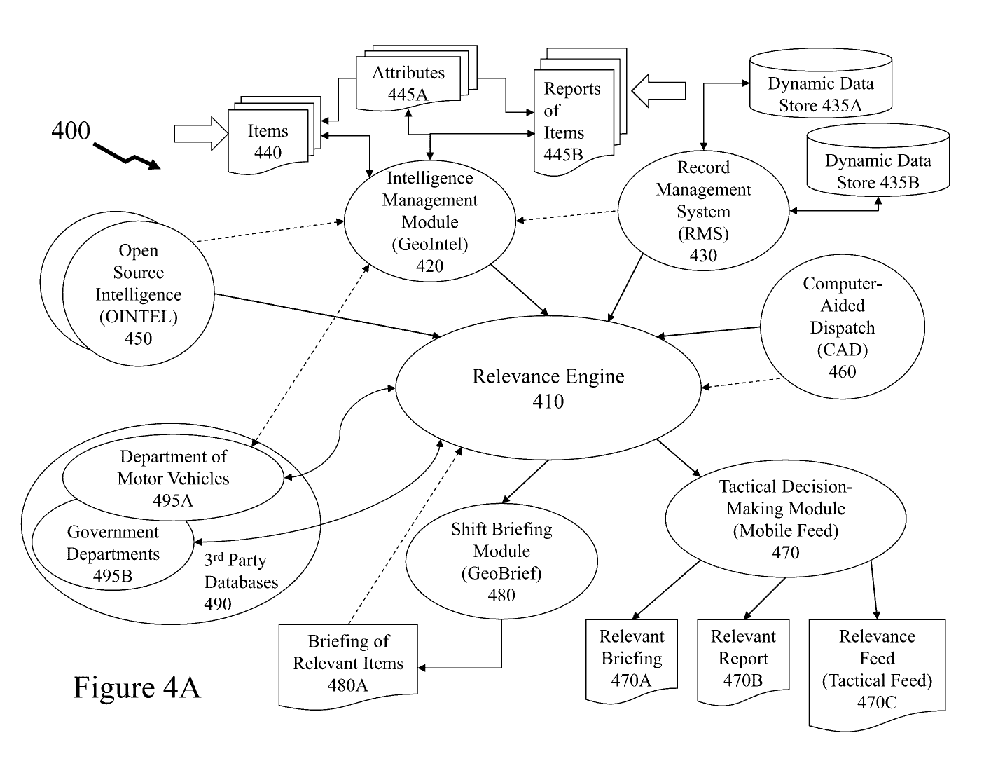

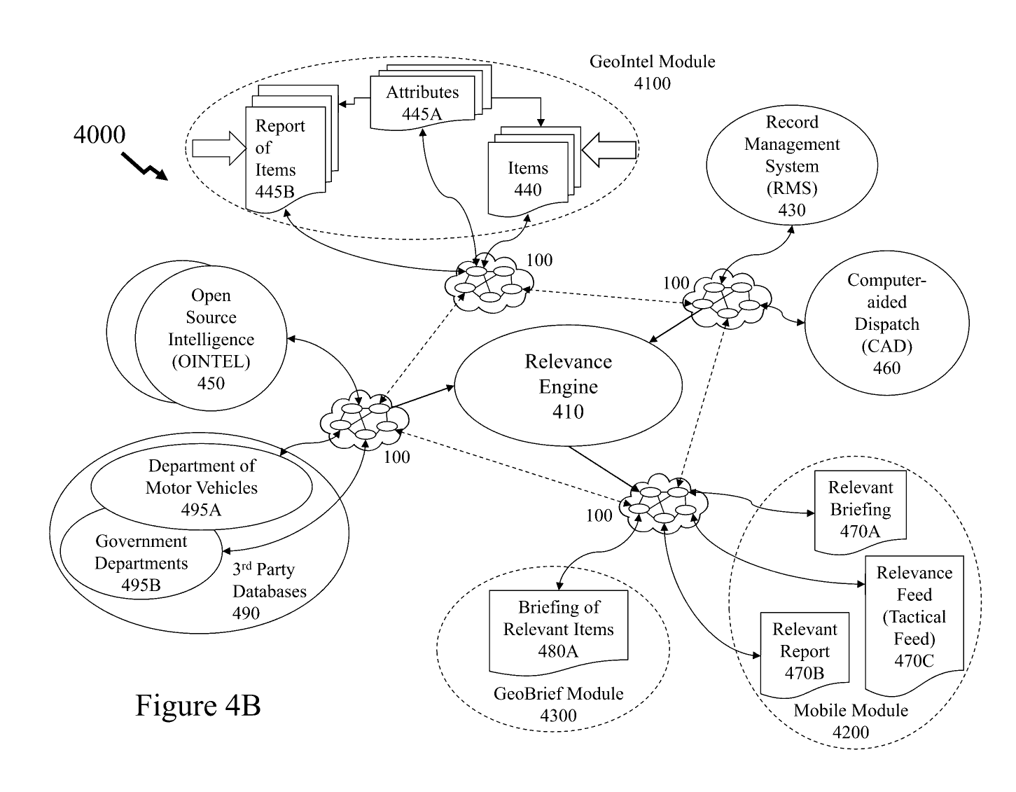

Referring to FIG. 4A there is depicted schematically a first software platform 400 supporting embodiments of the invention as a framework of modules with exemplary interconnections. Accordingly, as depicted at the core of the software platform 400, e.g. a LESLEAP as described supra, there is a relevance engine (RELENG) 410 which receives data from multiple platform modules (elements) both internal and external to the LESLEAP itself. Examples of such platform modules typically defined as internal include:
Intelligence Management Module (GeoIntel) 420 is a Geospatial Content Management System (GeoCMS) which manages content in the form of Items 440, Attributes 445A, and Reports of Items 445B which are stored internally and/or external links (not shown for clarity but indicated through arrows) to organization infra-structure elements, e.g. website, telephone calls, anonymous tips, news feeds, etc. and third party organization infra-structure elements look, e.g. Arizona Highway Patrol, other Divisions, other city police forces, e.g. Phoenix Police Department;
Record Management Systems (RMS) 430 which retrieve information from data stores, such as first and second Dynamic Data Stores 435A and 435B respectively which, for example, store historical records such as BOLOs, officer reports, crime records, warrants, briefings, etc.; and
Computer-aided Dispatch (CAD) 460 which traditionally assigns an officer based upon responses, current tasks etc. wherein due to the context and location aware nature of embodiments of the invention may be simplified as officers who cannot respond due to current context and/or location are not receiving the request but now will allocate based upon additional information such as is there an existing case relating to the location, caller, suspect, etc.

Examples of such platform modules typically defined as external include:
Open Source Intelligence (OINTEL) 450, wherein the law enforcement agency may provide information to their neighbourhood(s), citizens, etc. as to actions, issues, etc. but also importantly receive information based upon citizens exploiting social media to give information such as by posting to Facebook™, tweeting on Twitter™, adding images to Instagram™ etc. and accordingly may access to push information to or retrieve information from social media, social media networks, as well as other third party information acquirers, aggregators, providers etc.; and
3rd party Databases 490 wherein data is requested and extracted in respect of individuals, properties, etc. wherein such 3^{rd} Party Databases may include, for example, Department of Motor Vehicles 490A allowing address information, vehicle registrations, etc. to be queried and Government Departments 490B such as Federal Bureau of Investigation (FBI), Department of Justice including their Bureau of Alcohol, Tobacco, Firearms and Explosives, Department of Labor, Inland Revenue Service, etc.

The RELENG 410 also provides data to multiple platform modules (elements) both internal and external to the LESLEAP itself. Examples of such platform modules include:
Computer Aided Dispatch 460 as described above;
Shift Briefing Module (Geo-Briefing) 480 which allows automatic generation of briefings by division, shift, location, etc. at the direct daily operational level as well as generation of briefings at higher levels such as city, district, etc. and provisioning said briefing content to officers electronically when in the field; and
Tactical Decision-Making Module (Mobile Feed) 470 which acts in combination with the RELENG 410 to filter the content based upon a pull request from the officer such that the officer is provided with a current prioritized feed of issues, items, reports, etc. relevant to their activities.

As depicted Shift Briefing Module 480 generates a Briefing of Relevant Item 480A whilst Tactical Decision-Making Module 470 provides a Relevant Briefing 470A to supervising officers, a Relevant Report 470B for supervisory or managerial officers, and a Relevance Feed (Tactical Feed) 470C for the officers themselves.

Optionally, the RELENG 410 may also provide information to a third party system or third party systems for storing data and performing relevance analysis on that stored data which is then provided back to the RELENG 410 and/or the LESLEAP. Optionally, the RELENG 410 may provide information to one or more third party relevancy analysis and data processing systems wherein returned data is decoupled from the provisioning as the returned data is based upon relevancy analysis and data processing across wider geographic, temporal, and/or contextual ranges than that associated with the RELENG 410 within its normal remit of operations. For example, all US police departments in every city may push data to the FBI and Department of Homeland Security wherein the analysis is decoupled from day-to-day city police activities and geared to national security, cross-jurisdictional issues etc. It would be evident that Record Management Systems (RMS) 430 may in fact be Real-Time Data Management System supporting dynamic real-time updating, e.g. as required within environments such as emergency services, active military operations, etc. operating discretely or in combination with other data/record/content management systems with different degrees of dynamics from frequent to infrequent or static such as with an archival data management system.

Referring to FIG. 4B there is depicted schematically a second software platform 4000 supporting embodiments of the invention as a framework of modules with exemplary interconnections wherein the RELENG 410 is one of a plurality of modules linked via the Internet, depicted as network 100, rather than any implied direct specific networks which may have been implied with respect to FIG. 4A although such direct interconnected elements may be implemented within embodiments of the invention. Accordingly, also connected to network 100 and therein to the RELENG 410 are the following elements:
GeoIntel Module 4100, equivalent to Intelligence Management Module 420 in FIG. 4A which is a Geospatial Content Management System (GeoCMS) which manages content in the form of Items 440, Attributes 445A and Reports of Items 445B;
RMS 430;
CAD 460;
OINTEL 450;
3rd Party Databases 490;
GeoBrief Module 4300 which comprises Briefing of Relevant Items 480A; and
Mobile Module 4200 comprising Relevant Briefing 470A, Relevant Report 470B, and Relevance Feed 470C respectively.

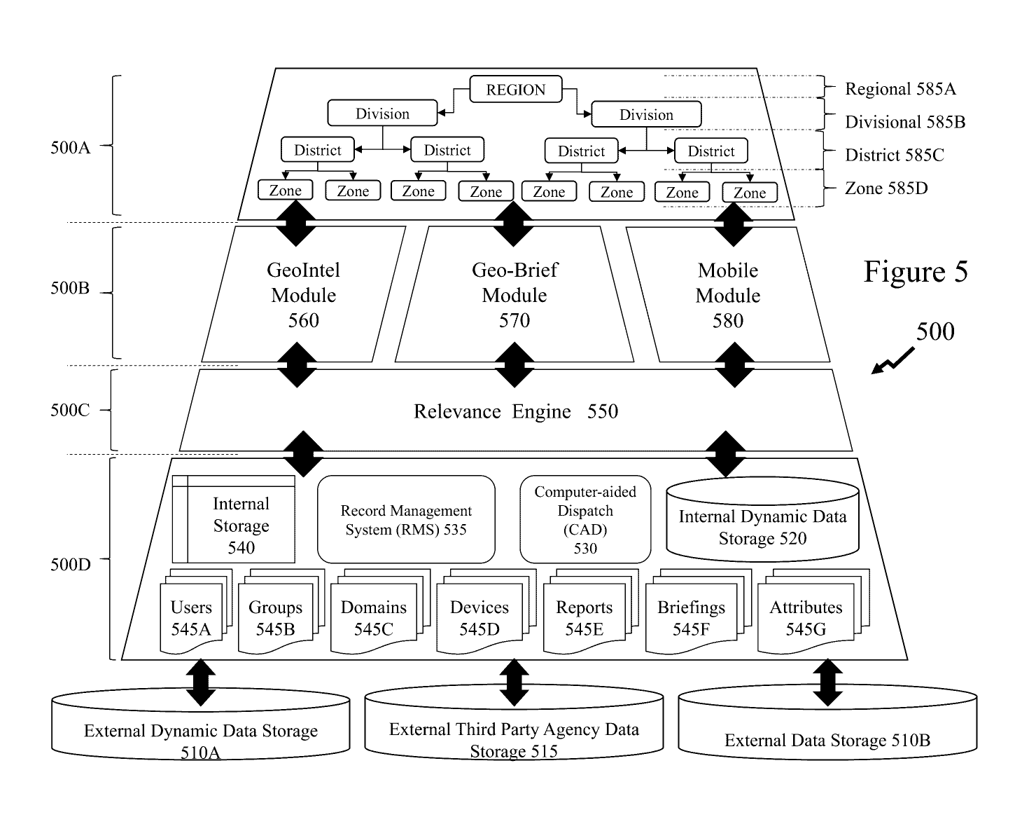

Now referring to FIG. 5 there is depicted schematically in hierarchal form a software platform supporting embodiments of the invention as a framework of modules with exemplary interconnections. Accordingly, the hierarchy 500 is depicted as 4 layers 500A to 500D with external dynamic data storage 510A, external data storage 510B, and external 3^{rd} party agency data storage 515 providing data to fourth layer 500D such as described above in respect of FIG. 4. Accordingly, within the fourth layer 500D are:
Internal storage 540, which stores data relating to the organization and its activities which is not as time sensitive and/or dynamic as other data;
Real-Time Data Management Systems 535, such as described above;
Computer Aided Dispatch 530, such as described above;
Internal Dynamic Data Storage 520, which stores data relating to the organization and its activities which is time sensitive and/or dynamic relative to other data;
Users 545A, which stores identities of organization members and others with credentials associated with the organization who may access, add, retrieve, modify data within the LESLEAP;
Groups 545B, which stores associations of users stored within data store Users 545A with other users in order to establish hierarchy, establish shifts, etc.;
Domains 545C, which stores associations of users stored within data store Users 545A with geographical and/or temporal data in order to establish zones of responsibility for users, e.g. patrol zones, district/division associations etc.;
Devices 545D, which stores associations of users stored within data store Users 545A with PEDs/FEDs;
Reports 545E, such as described in respect of Relevant Reports 470B in FIGS. 4A and 4B respectively;
Briefings 545F, such as described in respect of Relevant Briefings 470A in FIGS. 4A and 4B respectively; and

Items and Attributes 545G, such as described in respect of Items 440 and Attributes 445A in FIGS. 4A and 4B respectively. These all feed the RELENG 550 within the third layer 500C which in conjunction with the processing elements in the second layer 500B provides the contextually, locationally, and temporally aware filtering/processing/distribution/collation. These processing elements within the second layer 500B being depicted as:
Geo-Intel 560, functionally similar to geo-intelligence 420 in FIG. 4;
Geo-Briefing 570, functionally similar to briefing and geo-briefing 480 in FIG. 4;
Tactical “Mobility 580, functionally similar to tactical mobile feed 470 in FIG. 4.

The results from these processing elements in combination with the RELENG 550 are provided to the organization's members, e.g. the law enforcement officers, based upon pull requests from the officer's PEDs and/or FEDs based upon their identities, groups, and domains as stored within the data stores Users 545A, Groups 545B, and Domains 545C within the fourth layer 500D. For example, Groups 545B may assign users within User 545A based upon their region(s) using Regional tags 585A, their division(s) using Divisional tags 585B, their district(s) using District tags 585C, and their zone(s) using Zone tags 585D. Accordingly, a Superintendent may be tagged to a division, a Chief Superintendent to a region, a sergeant to a district and an officer to a zone. Depending upon the officer's patrol route they may be associated with multiple zones wherein the sequence of zones results in temporal tags, not depicted for clarity. In a large district a sergeant may be associated with a subset of zones and different shifts similarly yielding temporal tags for them such that they will be provided information based upon the overall geospatial temporal tag combination combined with the other feed information associated with their zone, district, division etc.

Accordingly, the LESLEAP as described supra in respect of FIGS. 4 and 5 can provide an organization or agency, e.g. law enforcement agency, emergency service agency, military unit, etc. with a software platform allowing them to derive, according to the degree of integration within their organization and interfaces to third party agencies, benefits including, but not limited to:
Increased alignment of day-to-day operations with strategic initiatives;
Resource efficiencies through automation of manual processes;
Effectively direction of proactive initiatives for the front line;
Enables improved communications throughout the organization;
Enables focused communications improving user attention/retention;
Increases situational awareness and officer safety;
Enhances regional information sharing and collaboration;
Reduces dependency on email for operational information sharing;
Optimizes distribution of centrally stored information;
Distribution of new information made at earliest appropriate opportunity based upon officer context and environment.

Beneficially embodiments of the invention support:
Actionable priorities targeted by area of responsibility or functional unit;
Increased retention and comprehension of shift briefing information using multimedia presentation;
Supervising officers are able to prioritize content for the front line;
Quality of intelligence is increased with standardized and consistent entry;
Analysts are able to prioritize content for the front line at the district level based on the decisions made by commanding officers;
Enhanced information discovery and readership by various information feeds;
Optimal servicing of actionable priorities and situational awareness using contextual metadata;
Instantaneous feedback and collaboration with the front line;
Secure information sharing with only those who need to see it based on standard operating procedures; and
Automation and standardization of the shift briefing process.

Within the prior art information is typically stored within a plurality of formats including, for example, documents, spreadsheets, and email which are difficult to search individually and even more challenging to search in their entirety. Further, such systems are not designed for identifying new information that might be relevant and adding this to pulled information content automatically to the officer in the field in real time. Further, this information is not structured such that geospatial content can be utilized when searching, reporting, and analyzing the data. Equally, the lifecycle of the information captured is not managed and causes clutter. Alternatively, information is removed completely and not archived correctly so history is lost making retrospective search and analytics difficult

The results within the prior art are poor readership levels for the information that is sent out within an organization and without proper integration the information is replicated across multiple systems. Equally, new information created such as patterns/trends, BOLOs and bulletins are not correctly linked to a single source of content (sometimes referred to as the “source of truth”) which is trusted without heresay or misinterpretation. Systems such as the real time data management systems provide for this.

This is not eased by information sharing being typically through emails which are reviewed typically by recipients based upon the subject line which is limited length and generated usually by the sender. Equally recipient groups are usually defined by hierarchy assumptions and IT so that everyone within a particular group receives the message whether or not it is relevant to them. Further such email systems have no time order except time of sending and hence are usually out of order and not based on relevance to any recipient. As a result, sharing an item of intelligence requires putting it on a shared drive hoping it read or sending it back and forth via email. Alternatively, sensitive information could be shared inadvertently with the wrong recipients.

Information dissemination through briefings are commonly based upon a collection of emails and other hardcopy information that is printed, discussed, and passed around leaving those being briefed taking notes with no way to recall the information presented which also leads to a lack of focus, comprehension and retention. Collaboration within prior art methodologies is hampered by inconsistent feedback to recipients that an issue has been resolved and that real-time feedback on actions that have been taken, i.e. checking an address, making an arrest etc., is not disseminated.

Accordingly, a LESLEAP according to an embodiment or embodiments of the invention addresses these prior art limitations through the platform and hierarchy described and depicted in respect of FIGS. 4 and 5 respectively that operate within the context of the network described in respect of FIGS. 2 and 3 with electronic devices, either PED or FED, as described in respect of FIG. 3. Accordingly, a LESLEAP according to embodiments of the invention allows an organization to leverage and augment existing investments in Information Technology (IT) systems and information by overlaying to their infrastructure and supporting interfaces to third party software, such as computer aided dispatch for example. Accordingly, a LESLEAP provides for standardized sharing and prioritization of operational information. Within the descriptions and “item” as used herein may refer to, but is not limited to, information managed within the LESLEAP as well as 3rd party information such as warrants, BOLOs, etc. where externally generated which are synchronised with systems such as the Real Time Data Management Systems, e.g. RTDMS 430 in FIG. 4. A “report” as used herein may refer to, but is not limited to, a weekly/bi-weekly package of Items targeted at a specific area of responsibility by analysts. A “briefing” as used herein may refer to, but is not limited to, a daily package of items targeted at a specific area of responsibility and shift by supervising officers. Accordingly, the LESLEAP determines relevant information which is then delivered to the front line officers via a Tactical Feed, e.g. Tactical Mobile Feed (TAMOF) 470 in FIG. 4, based on their current situation which includes geospatial and tempero-spatial information as well as context and environment. Accordingly, the officer's situation determines an ability to receive/consume information wherein it is pulled based upon the output from the RELENG 410 from the TAMOF 460. Items included within a report or briefing become a key human operational signal for prioritizing information within the TAMOF 470.

Operational information commonly shared within the platform, from a law enforcement organization viewpoint may include, but not be limited to, warrants, individual release conditions (e.g. bail, Court sentence, etc.), crime and intelligence reports, bulletins, broadcasts, BOLOs, FYIs, recent releases, and patterns/trends. Unlike prior art methodologies the LESLEAP is a Real Time Relevant Information Sharing Platform to provide organizations, e.g. law enforcement agencies, with information management via the RTDMS 430, RELENG 410, and TAROF 470 to ensure their front line resources are situationally aware, utilized to their full capacity, and have the information to improve effective expenditure of their limited resources. Unlike prior art methodologies the LESLEAP according to embodiments of the invention prioritizes information contextually in real-time using the RELENG 410 in conjunction with the RTDMS 430 and provides this to the recipient(s) via the TAMOF 470. The RELENG 410 automatically surveys actionable priorities and situational awareness such as patterns/trends, bulletins, warrants, conditions, broadcasts, BOLOs, etc. for front line officers in to provide both reactive and proactive situations. This helps agencies increase productivity and safety by ensuring that officers have the right information when and where they need it most. At the same time the TAMOF 470 provides this information when the front line officer can process this information and hence relies primarily upon pull triggers from the officer's PED and/or FED but may push high priority information directly relevant to the officer.

Referring to the second layer 500B in FIG. 5 within the hierarchy 500 then Tactical Mobility 580 is a Tactical Decision-making Portal (TDP), e.g. TAMOF 470, for front line officers on the move who don't have time to search multiple sources for actionable priorities or situational awareness information during discretionary time or while responding to a call for service. Unlike prior art email and record management systems which are un-prioritized, Tactical Mobility 580 leverages multiple information repositories in a contextually relevant manner based on the officer's current situation taking into consideration proximity, location assignment, staleness, and importance. Human direction may be used as the highest weighting factor for the automated ranking of information such that briefing data is prioritized higher or a new event can be immediately made highest priority for that officer or officers once their context allows it.

Referring to the second layer 500B in FIG. 5 within the hierarchy 500 then Geo-Briefing Module 570 is a Geospatial/Geo-Temporal Briefing Management System (GeoBMS) for supervising officers and communication centre staff who require standardized and consistent information delivery such that, for example, briefings such as shift briefings are relevant, i.e. to an area of responsibility and shift, and linked to the Tactical Mobility 580 such that the information is accessible to the officers post-briefing and may be prioritised automatically above other tasks.

Referring to the second layer 500B in FIG. 5 within the hierarchy 500 then Geo-Intel 560 is a Geospatial/Geo-Temporal Content Management System (GeoCMS) for analysts and investigative officers with or without a centralized repository for disseminating crime reports, situational awareness and other actionable priorities such as bulletins, recent releases, BOLOs, broadcasts, patterns/trends etc. As with the other aspects of LESLEAP then the GeoCMS targets information by location, role, responsibility, etc. in order accurately feed information through the organization.

As depicted in FIG. 5 within the third layer 500C underlying the Geo-Intel 560, Geo-Briefing 570, and Tactical Mobility 580 modules in the second layer 500B of hierarchy 500 is the RELENG 550. This provides the Geospatial/geo-temporal filtering of content stored within the overall system to support the Geo-Intel 560, Geo-Briefing 570, and Tactical Mobility 580 modules as specifically required by each officer within the organization. Accordingly, even though all officers with, for example the Tucson Police Department, are connected to the same LESLEAP an officer in Sector 8 of the Operations Division East 130C in FIG. 1 may be provided different information through TAMOF 470 that that provided to an officer in Sector 7 of the Operations Division East 130C, an officer in Section 1 of Operations Division South 130E, or even another officer in Sector 8 of the Operations Division East 130C on the same shift due to their Geospatial information, context, environment etc.

Underlying the RELENG 550 in FIG. 5 is the fourth layer 500D which comprises a plurality of databases and software applications including, for example, the Real Time Data Management Systems (RTDMS) 535, e.g. RTDMS 430 in FIG. 4, in conjunction with a plurality of data sources including, but not limited to, Internal Storage 540, Internal Dynamic Data Storage 520, External Dynamic Data Storage 510, and External Third Party Agency Data Storage 515. Accordingly, the RTDMS enables to RELENG 550 to access existing information and newly generated information relating to items such as warrants, conditions, BOLOs, FYIs etc. Historical records may be stored within, for example, Internal Storage 540, external data storage 510B, and external 3^{rd} party agency data storage 515. Current open tasks, activities, active investigations, etc. may be stored within, for example Internal Dynamic Data Storage 520 and External Dynamic Data Storage 510A as well as real-time news, content, 911 data, tip-off lines (e.g. telephone and/or email). Additionally, the RELENG 550 accesses organization databases such as Users 545A, Groups 545B, and Domains 545C in order to apply many of the Geospatial and geo-temporal rankings to data together with data from the Computer Aided Dispatch 530.

Accordingly, the RELENG 550 will dynamically change the prioritized information for an officer in Sector 8 of the Operations Division East 130C through TAMOF 470 based upon additional data such as that from CAD 510 and Devices 545D. Accordingly, CAD 510 identifies the officer as attending “Disturbance—Buddy's Grill” which is located at corner of E. Valencia Road and S. Houghton Road whereas Devices 545D identifies them as in their vehicle travelling east at speed. Accordingly, the user's context is probably closer to “Chasing Suspect—E. Valencia Road.” As evident from FIG. 5 these databases accessed by the RELENG 550 can be concurrently accessed and employed to provide information to the Geo-Intel 560, Geo-Briefing 570, and Tactical Mobility 580 such that not only does the officer in the field get prioritized information that they need but their supervisors, other officers, dispatchers etc. can all be updated in real time. Hence, a dispatcher and another officer may be advised that they can intercept E. Valencia Road quickly to aid the other officer. Further, as the data is entered once, e.g. through Devices 545D tracking an officer's smartphone Geospatial coordinates, then data re-entry is eliminated and maintained as a single source of truth.

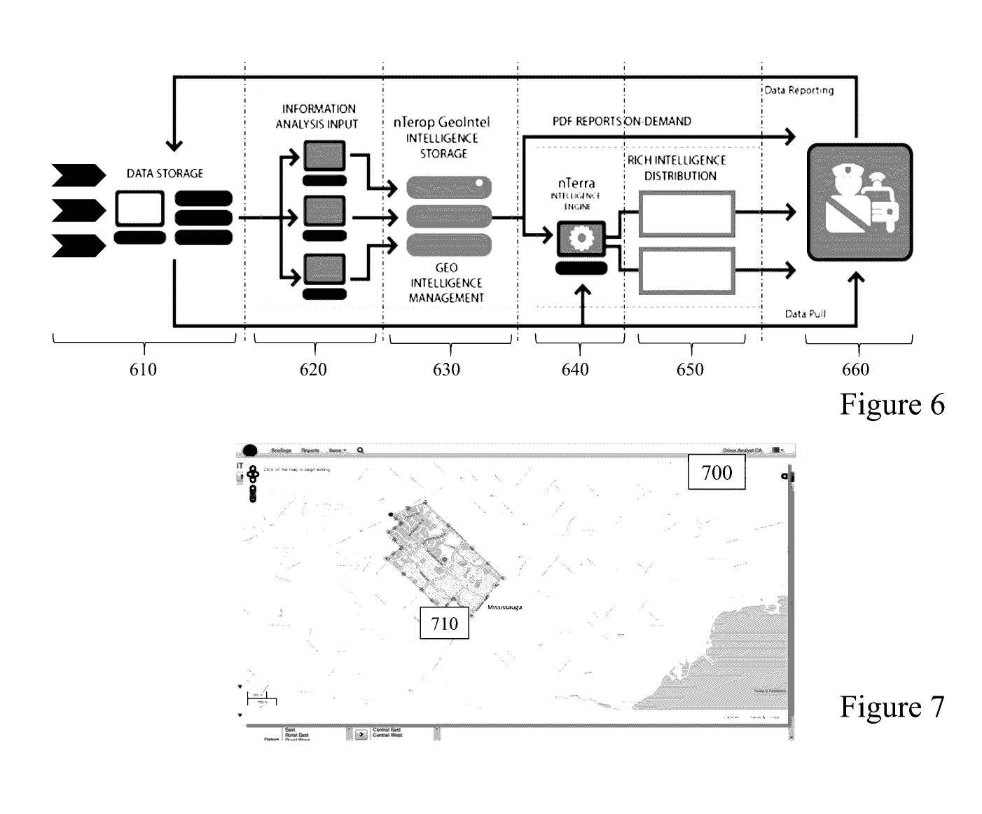

Now referring to FIG. 6 there is depicted a high-level information flow within an agency based on the relevant information flow model implemented by a LESLEAP according to an embodiment of the invention. As depicted the flow comprises essentially 6 stages 610 to 660 representing:
Stage 610 wherein data is added to data storage such as that generated by an officer in the field or from other resources, external agencies etc. including, for example, Internal Storage 540 and External Third Party Agency Data Storage 515;
Stage 620 wherein information analysis input provides additional information in addition to that stored within the data storage, including, but not limited to, officer shift, officer assigned zone(s), etc.;
Stage 630 wherein additional data is accessed relating to that entered in stage 620, such as through additional data storage including, for example, Users 545A, Groups 545B, Domains 545C, Devices 545D, Internal Dynamic Data Storage 520 and External Dynamic Data Storage 510A;
Stage 640 wherein information flow splits either to generating different reports in PDF format on demand, e.g. briefings, statistical reports, crime reports, public information, request for public's help, etc. or proceeds through the RELENG 550;
Stage 650 wherein the RELENG 550 data is provided through modules such as Geo-Briefing 570 to supervising officer(s) and Tactical Mobility 580 in FIG. 5 to the field officer(s), in each instance via a pull process based upon an indication of an ability to consume/receive additional information;
Stage 660 wherein the pull highest priority/highest relevancy information is presented to the officer based upon their status, task, Geospatial, and geo-temporal information, for example.

Accordingly, it would be evident that a LESLEAP according to embodiments of the invention provides for standardizing briefing processes, e.g. the shift briefing process, across divisions, districts and shifts. The shift briefing being where priorities are set and timely information is shared to support current investigations and protect officers. LESLEAP ensures that not only is current situational awareness information, actionable priorities and requests for information identified are not only delivered for the shift briefing, but also directly in part to those officers requiring it for their shift, and is accessible to other officers during the shift or subsequently. At the same time the LESLEAP according to embodiments of the invention provides front line officers in reactive and proactive situations with a consolidated front line feed that adjusts according to their current situation whilst also informing with respect to other decision-making/updates either during discretionary time or while responding to a call for service. Between calls or while floating around division or districts, officers can be made aware of officer safety bulletins, recent releases, and broadcasts that are relevant them even in a fluid and dynamic environment. As the LESLEAP is a pull system, except for specific high priority traffic, then the officers are not being fed information except when they can absorb it within the context of their activities.

It would be evident that as the LESLEAP, according to the embodiments of the invention described supra in respect of FIG. 4-6 and below in respect of FIGS. 7 to 14, stores data and information from a plurality of sources with respect to the organization operating the LESLEAP that it may be further leveraged for business intelligence and corporate planning purposes providing at various levels of granularity, e.g. per office, per shift, per division, per district, per officer, data on how resources are allocated and employed. Data can therefore be extracted from the system and used effectively in data warehouses enabling downstream reporting and charting. Data can include but is not limited to proactive initiatives prioritized across districts on a per shift basis, patterns/trends tracking and lifecycle, operational readership metrics, uniform crime reporting, ward reporting etc. Equally, the ability to establish such information allows an organization's Real-Time Operation Centres which are a key support mechanism for front line operations and therefore a key contributor and consumer of relevant information. In support of Real-time Operation Centres (RTOC), the LESLEAP allows for relevant sharing, communication and collaboration across divisions and districts. Historical, current and emerging operational information can be targeted at specific officers, groups of officers, locations, divisions, districts etc. ensuring delivery at shift briefing and at street-level as RTOC staff support large and very complex jurisdictions. At a higher level a LESLEAP or plurality of LESLEAPs support regional information sharing environments such that the LESLEAP(s) support federation allowing multiple agencies to share information on a single platform instance. Items, reports and briefings can be shared securely or globally with all partners ensuring delivery at national, regional, municipal, district, zone, shift, officer levels such that data generated, for example, by an officer in Sector 8 of the Operations Division East 130C relating to seizure of weapons in response to execution of a search warrant may be directed automatically to another officer within the Bureau of Alcohol, Tobacco, Firearms and Explosives.

Accordingly, the LESLEAP and its process flow provide for all or a subset of the following:
Context-aware Tactical Feed;
Context Management;
Contextual Business Rules Automation;
News Feed;
Geospatial Content Management;
Geospatial Briefing Management;
Geospatial Report Management;
Information Lifecycle Management;
Search;
Sharing and Automation;
Domain Management;
User and Group Management;
Desktop and Mobile Clients;
Filtered Views;
Realtime Data Management Integration;
CAD Integration; and
Bidirectional Data Feeds (Data Import—Data Export) from/to Third Party Databases and LESLEAPs.

Now referring to FIG. 7 there is depicted a geo-mapping feature within a LESLEAP supporting embodiments of the invention for assigning a primary zone for a law enforcement officer. As depicted a user of the LESLEAP is presented with a map 700 allowing them to define a geo-fenced region, e.g. a district, division, or zone for example, for association with an officer shift/assignment. In this instance the boundary was defined by a series of geo-markers defined by the user for a region of Mississauga, Ontario, Canada. In this manner, an officer assigned to the zone would be provided Geospatially relevant information when assigned to this region and within a predetermined distance of the geo-fence. For example, the officer may only receive a pull-based feed when the device associated with them whose location is tracked is within the geo-fenced boundary. Alternatively, a 100 m, 500 m, or other distance secondary zone offset around the primary zone may be established. In these instances, the officer would be aware of information relating to portions of the adjacent zones. Such zones may be temporally assigned to the user so that they only receive information within a predefined time range associated with their shift, e.g. 3 am-10 am when their actual shift is 4 am-10:00 am.

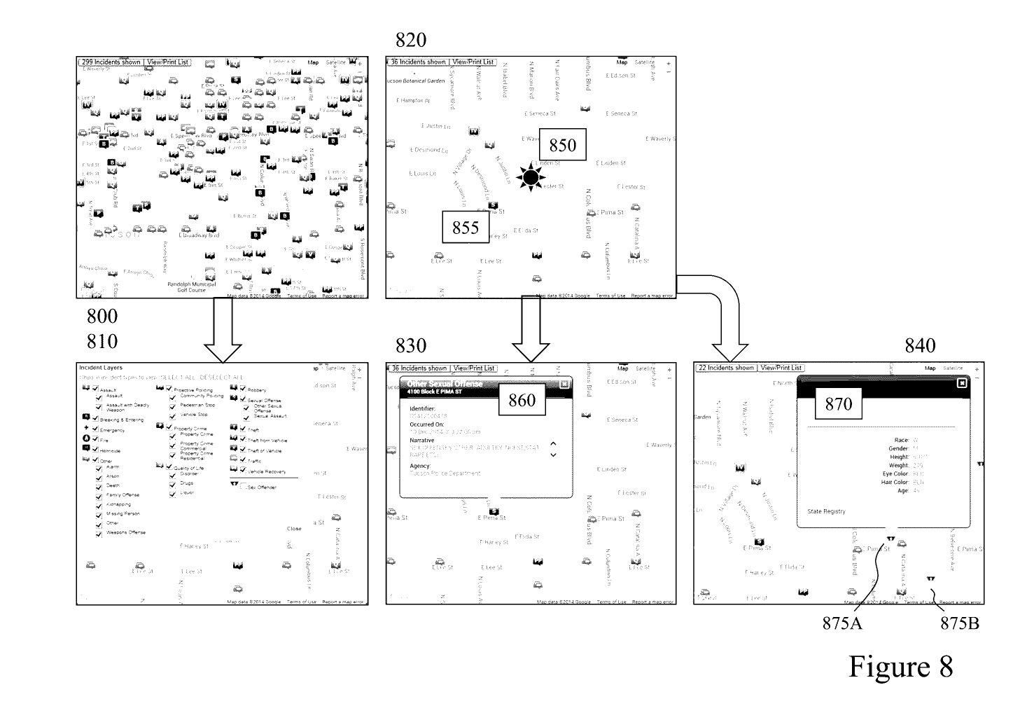

Referring to FIG. 8 first to fifth images 800 to 840 respectively depict exemplary map overlay images for a LESLEAP supporting embodiments of the invention when providing this to an officer in the field upon a PED/FED compatible with the display of such map overlay information. Accordingly, considering the user exploiting a tablet PC for example, such as within a police cruiser, then the user has requested an overlay of all reported incidents leading to first image 800 wherein all events within their zone are displayed. Optionally, the map may depict only their zone or depict their zone overlaid with a larger area of their surroundings. In second image 810 the user is able to select filters either by category of reported incident or specifically. For example, assault may be shown for all cases or solely those wherein a deadly weapon was identified as being involved. Where the officer selects a sub-set of cases then the map view is refreshed accordingly.

Alternatively, the user is presented with a map view such as that depicted in third image 820 wherein the events within the area are depicted over a predetermined period of time, e.g. those reported with past 12 hours, past 24 hours, and/or having a predetermined priority. Within this is a marker 850 which may be, for example, the officer's current location or defined marker, e.g. zone center. Optionally, the map may adjust to maintain the officer's current location central as they execute their shift. If the officer selects an item 855 then they may be provided through an overlay a short incident summary 860. In this instance, the short incident summary 860 denotes the item class “Other Sexual Assault”, the item's assigned location “4100 Block E Pima St”, together with item identifier, date-time of the event, brief narrative e.g. summary from officer taking report of item's occurrence, the agency responsible for the item. Based upon this the officer may search additional databases or these may be automatically searched based upon the item or the officer's selection of the item. In this instance fifth image 840 presents the items as per fourth image 830 together with additional data extracted from the State Sexual Offender registry identifying their registry registered addresses which are now identified by first and second markers 875A and 875B respectively. Selection of one of these results in database summary 870 being presented to the officer indicating in this instance that the registered offender associated with first marker 875A is a 45-year-old white male 6 feet tall, 279 pounds, with blonde hair and blue eyes. In other instances, for example with fourth image 830 and short incident summary 860 additional markers for eye-witnesses, etc. may also be presented to the officer.

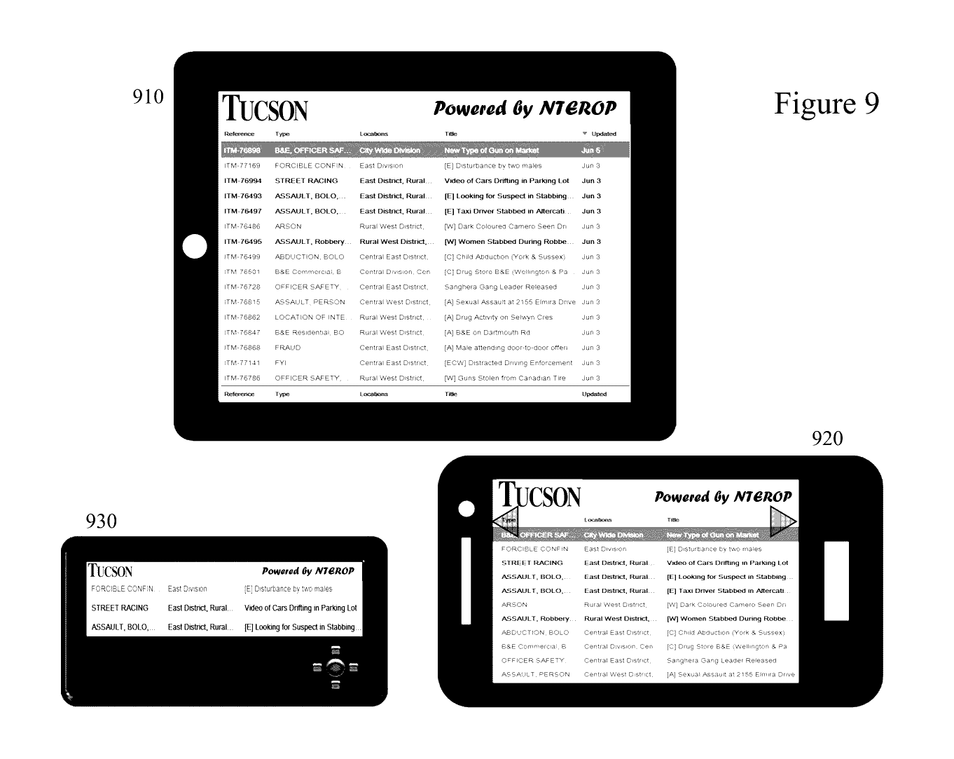

Now referring to FIG. 9 there are depicted first to third images 910 to 930 relating to device context aware incident presentation to a law enforcement officer according to a LESLEAP supporting embodiments of the invention. In each instance a tabular format item reporting, e.g. incident reporting, is presented to the user. However, the LESLEAP has associated with the user a device or devices and accordingly provides content for their prioritized tabular item listing in dependence upon this. Accordingly, if the officer has a tablet then content such as depicted in first image 910 is provided, if a smartphone content such as depicted in second image 920 is provided, and if a pager restricted content such as depicted in third image 930 is provided. In each instance the data is prioritized based upon the officer's Geospatial location and limited based upon the device upon which they are receiving it. Similarly, where the officer selects an item and is presented auxiliary information then this is similarly filtered to accommodate the device upon which the officer will be viewing it. If the officer has multiple devices then the LESLEAP provides the content to each device according to its capabilities such that whilst the officer may be only able to access a pager, for example, on foot out of their cruiser, they can access the tablet when back within the cruiser.

Items within the LESLEAP may have multiple states associated with them as an indicator of the current stage of the item. States would be able to enforce process such as no updating information, not collaborating on the item, etc. The system may support the following states, for example:
Draft—Initial stage of a newly created item, only visible to creators or delegates
Pending Approval—Items that require assessment and approval will remain in this state until they are either approved and published or rejected and archived.
Published—Visible to all participates and delegators and available for collaboration
Resolved—Item has been flagged as resolved, once acknowledged or read is will be archived.
Archived—Searchable and retrievable but removed from general visibility. Can no longer be edited or modified.

Items can have an associated explicit priority that is explicitly changed and allows an item to be adjusted to a higher or lower priority for the users it is relevant to. Authorized users have the ability to explicitly set priority. Crime analysts, for instance, would create the item and target it to a demographic of officers. However, the staff sergeant managing those officers would explicitly set the priority before officers become involved. Equally, items can have an associated implicit priority that is set automatically by the LESLEAP which is set based on attributes such as item type, time/date, when the item must be resolved by, etc. Accordingly, implicit priority to an assault, murder etc. may be higher than theft from vehicle, for example. Items also support a history which allows the full life cycle of an item to be easily audited such that, for example, the system must clearly state who changed what information related to an item, what it was previously and when it was changed. The LESLEAP also provides a level of access control when viewing an items history between users. For instance, traffic police might not be able to see history of an item from the drug unit even if the item should still be relevant to both groups. However, such access control may be non-reciprocal or reciprocal. Items support the ability to include attachments which can be added to the LESLEAP at the time of creation or subsequently. In some embodiments the LESLEAP may support a social media content engine that extracts and/or identifies social media, blog, web, news content associated with an item.

Other aspects of items within LESLEAP include:
Time Tracking: The system will be able to match a user's location history (either through the system or by integrating with an external system) with the items presented to that officer while they were there. From this time can be implicitly associated with items allowing an organization's department to show that they are effectively providing proactive support.
Explicit Time Tracking: The system will also support manual time entry against items. An officer will be able to select the item they were working on and enter an amount of time they spent working on it.
Explicit Exclusion: An officer may explicitly exclude items from their inbox in the event it is not useful or is irrelevant. This may include a feature to temporarily dismiss an item for a period of time rather than totally excluding the item.
Revoking: All items that are created in the system can be revoked by the user who created them, a delegate acting on behalf of that user or an authorized user. This will archive the item and remove it from active use. When this happens it would be necessary to display that the item has been revoked but after that point it is only visible to the staff sergeants and not the officers directly. For example, there are some circumstances when crime analysts send out information regarding addresses. There may have been a major surveillance of the address and they would like to revoke any information so that officers are not treating that address differently. The system may leave traces of the item in the form of a placeholder that explicitly says it has been revoked. However, the item itself will not display the original content. Officer can then remove the revoked it from visible display in the inbox.

LESLEAP may also support:
Delivery & Read Capture: Items must support delivery and read metrics as they become relevant to officers and are consumed. A user, as authorized, should have the ability to view if an item was read or not by its participants or by the territory it is relevant to. This gives insight into who actually opened the item and for how long they reviewed it.
Acknowledgements: Items of various types must allow users to acknowledge the reading of the item and it they understood the information. For example, when a policy update is sent out officers will need to acknowledge that they have read the policy update and that they understand it through an acknowledgment (typing initials) or through a simple question pertaining to the material.
Assessments & Approvals: Items can be subject to an assessment and approval process before being generally available. This is used as a control mechanism and can be applied to items of various types and sources based on pre-set rules.
Templates: The system must support item templates. This allows users to create items faster and pre-populate them with information based on business rules associated with the template. Templates can be associated with item types. Global templates can be configured by the system administrator. The system may also support personalized templates users can create and configure.
Incorrect Information: When information is shared, there must be an easy mechanism to display whether information is incorrect without removing it or editing it. The purpose is so that the information is not assumed as correct by officers. There may be additional markup overtop of the information (such as a strike-through line) or a simple flag or indicator. The look and feel should be very intuitive in nature.
Verification of Information: When information is shared, there must be an easy mechanism to display whether information has been verified or not. This may be additional markup overtop of the information or a simple flag or indicator. The look and feel should be very intuitive in nature.

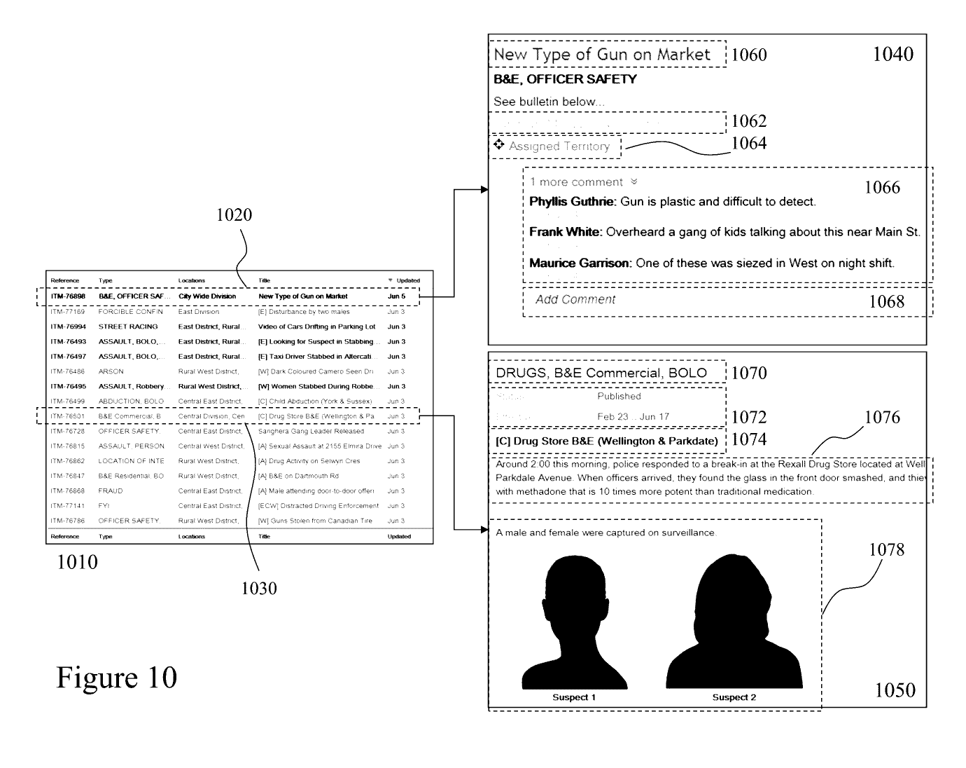

Accordingly, referring to FIG. 10 there are depicted first and second secondary information screens 1040 and 1050 relating to first and second specific incidents 1020 and 1030 selected by a law enforcement officer within a prioritized item list 1010 provided to the officer by a LESLEAP supporting embodiments of the invention. Accordingly, first specific incident 1020 leads to first secondary information screen 1040 wherein the information presented includes title 1060, generator of the item 1062, why the item has been provided to the officer (e.g. relates to their assigned territory), comments 1066, and a field for the officer to add a comment 1068. Second specific incident 1030 leads to second secondary information screen 1050 wherein the information presented includes title 1070, details of issuance 1072, location of event 1074, summary of event 1076, and images 1078 extracted from surveillance footage of the event. Again such secondary information screens may be modified based upon the device upon which the user is viewing so that the officer is presented with the key information quickly in a format that minimizes their time spent navigating screens, menus, content etc. to acquire the key information.

As discussed through the specification in respect of embodiments of the invention items are displayed to the user based upon a prioritization. Within some organizations officers may be “Patrol” or “Floater” wherein the former have an assigned zone or zones whilst the latter may be assigned to a division/district for example allowing them to provide support according to activities during the shift or across shift transitions if their shifts are offset relative to the patrol officers.

Considering “Patrol” then prioritization is based upon the assigned zone for the officer and their current location (if available) and the LESLEAP prioritization focuses to actionable information. Examples of items pulled to the officer's PED/FED may include, but are not limited, given in Table 1 below. (Situational Awareness=SA). Optionally, in addition to the items listed within Table 1, other items may be pulled to the officer's PED/FED including, but not limited to, shift briefing Standard Operating Procedures (SOPs), assigned user identity of the officer, assigned group of the officer, officer safety information, and priorities.

TABLE 1
Patrol Item Prioritization

| Name | Description | Type |
|---|---|---|
| Item with geospatial | Item with points, lines, polygons immediately | Action |
| markups nearby | around you (e.g. ~500 m or 1-5 city blocks). | |
| | Items with maximum travel times (e.g. 5 minutes | |
| | walk or a couple of minutes drive) | |
| | Can be acted on immediately | |
| Item in Briefing targeted to | Supervisor thought it was important. | Action |
| assigned zone | Can be acted on in the current shift. | |
| | Since it's specifically targeted at an officer's zone, | |
| | they are the one most able to act on it. | |
| Items in Report targeted to | Analyst/District Meeting thought it was important. | Action |
| assigned zone | May not be immediately actionable. | |
| | Since it's specifically targeted at an officer's zone, | |
| | they are the one most able to act on it. | |
| Item targeted to assigned | Since it's specifically targeted at an officer's zone, | Action |
| zone | they are the one most able to act on it. | |
| | The fewer other zones the Item is targeted to the | |
| | more relevant. | |
| General Item in Briefing | Supervisor thought it was important. | Action |
| | Officer needs to be aware of it. | |
| | Focuses primarily on information targeted to the | |
| | district. | |
| | If it is only targeted to other zones it will be ranked | |
| | significantly lower. | |
| General Item in Report | Analyst/District Meeting thought it was important. | SA/FYI |
| | Officer needs to be aware of it. | |
| | Focuses primarily on information targeted to the | |
| | district. | |
| | Staleness is a large factor. | |
| Item targeted to district | Is more relevant to floater vehicles. | SA/FYI |
| (district that contains | It is more of an FYI type of information. | |
| assigned zone) | | |
| Item targeted to buffer zone | Targeted to officers in a neighbouring zone. | SA/FYI |
| | Allows officer to know what other officers are | |
| | dealing with nearby and be prepared to take over the | |
| | zone due to a long running call. | |
| | It is more of an FYI type of information. | |
| Item targeted to division | FYI Only | SA/FYI |
| (division that contains | Should show up for all officers | |
| assigned zone) | Unlikely to be actionable | |
| Officer Safety Item | Important to everyone. | SA/FYI |
| | Unlikely to be actionable. | Important |
| | This is a FYI but with a high level of importance. | |
| | This might be ranked higher since everyone should | |
| | read all Officer Safety issues but as not actionable it | |
| | should remain, perhaps, below such items. | |

Considering “Floater” or “Floater Patrol” then prioritization is based upon the assigned district, or division etc., for the officer and their current location (if available) and the LESLEAP prioritization focuses to actionable information. Examples of items pulled to the officer's PED/FED may include, but are not limited, given in Table 2 below based upon the floater patrol providing a coordination role, should be able to take on issues that are less relevant to patrol officers, and needs to know about current location for Situational Awareness (SA) purposes.

TABLE 2

| Name | Description | Type |
|---|---|---|
| Item with geospatial | Item with points, lines, polygons immediately | Action |
| markups nearby | around you (e.g. ~500 m or 1-5 city blocks). | |
| | Items with maximum travel times (e.g. 5 minutes | |
| | walk or a couple of minutes drive) | |
| | Can be acted on immediately | |
| Item in Briefing targeted to | Has the freedom to move throughout the district | Action |
| district (district that | Act on & resolve from a high level | |
| contains assigned zone) | More likely floater can action than an officer | |
| | assigned to a zone | |
| Item in Briefing targeted to | Needs to know what the officer assigned to that | Action |
| current zone (zone officer | zone sees | |
| is currently at) | Can support acting on that information | |
| Item in Briefing targeted to | Less specific to each officer in the targeted zones | Action |
| multiple zones | Better able to coordinate across multiple zones | |
| | The more zones targeted, the higher the rank | |
| Item in Report targeted to | Has the freedom to move throughout the district | Action |
| district (district that | Act on & resolve from a high level | |
| contains assigned zone) | More likely floater can action than an officer | |
| | assigned to a zone | |
| Item in Report targeted to | Needs to know what the officer assigned to that | Action |
| current zone (zone officer | zone sees | |
| is currently at) | Can support acting on that information | |
| Item in Report targeted to | Less specific to each officer in the targeted zones | Action |
| multiple zones | Better able to coordinate across multiple zones | |
| | The more zones targeted, the higher the rank | |
| Item targeted to district | Has the freedom to move throughout the district | Action |
| | Act on & resolve from a high level | |
| | More likely floater can action than an officer | |
| | assigned to a zone | |
| General Item in Briefing | Unlikely to be in the exact zone to action (i.e. ⅙ | SA/FYI |
| | chance of being in a specific zone) | |
| | Should know what other officers are looking into | |
| General Item in Report | Unlikely to be in the exact zone to action (i.e. ⅙ | SA/FYI |
| | chance of being in a specific zone) | |
| | Should know what other officers are looking into | |
| Officer Safety Item | Important to everyone | SA/FYI |
| | Likely not actionable since it's not targeted to your | |
| | zone/district/location | |
| | This is a FYI but with a high level of importance | |
| | Note - this should likely be ranked higher since | |
| | everyone should read all Officer Safety | |
| | issues . . . however since it's not actionable it should | |
| | remain high | |

Overall a LESLEAP may employ a few guiding principles including, for example:
The more specific the targeting information the higher it will rank;
Signals from other officers may increase/decrease relevance;
Supervisor will rank information through a briefing for immediacy whilst an analyst will do the next best job with a report but does not have shift by shift visibility;
The more people that can act on it the lower it will be absent other factors;
Information is provided within a limited number of classes, e.g. Actionable (can be immediately actioned by the officer) and Situational Awareness (SA)/FYI (the officer should know it but it's unlikely they can act on it immediately).

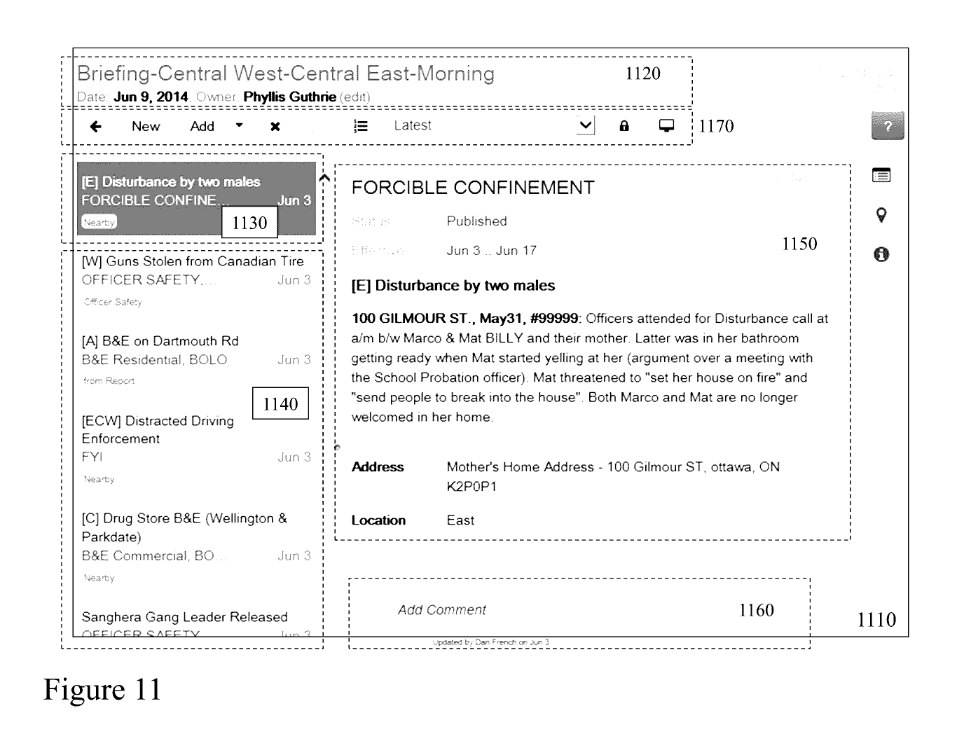

Similarly, referred to FIG. 11 there is depicted a briefing interface 1110 for a supervisory officer which is automatically generated for them by a LESLEAP supporting embodiments of the invention. Accordingly, as depicted in header 1120 the briefing interface 1110 identifies the briefing a relating to Central West/Central East divisions for the morning shift and being for Jun. 9, 2014 wherein the briefing “owner” is “Phyllis Guthrie.” Below this is toolbar 1170 allowing the briefing “owner” to add items, delete items, re-order items, override ranking, etc. as well as lock the briefing and push to a display, present, share with others, etc. Accordingly, on the left hand side is a list of briefing items prioritized from highest priority item 1130 down with remainder list 1140. Accordingly, as the briefing is provided then the items can be selected leading to the item detail 1150. A comment field 1160 is also provided for the briefing “owner” to add additional comments, review existing comments, etc. Comment field 1160 may display the last comment, indicate other comments are available, etc. as known in the art. Subsequently, the officers associated with Central West/Central East divisions for the morning shift may retrieve the briefing for use during their activities.

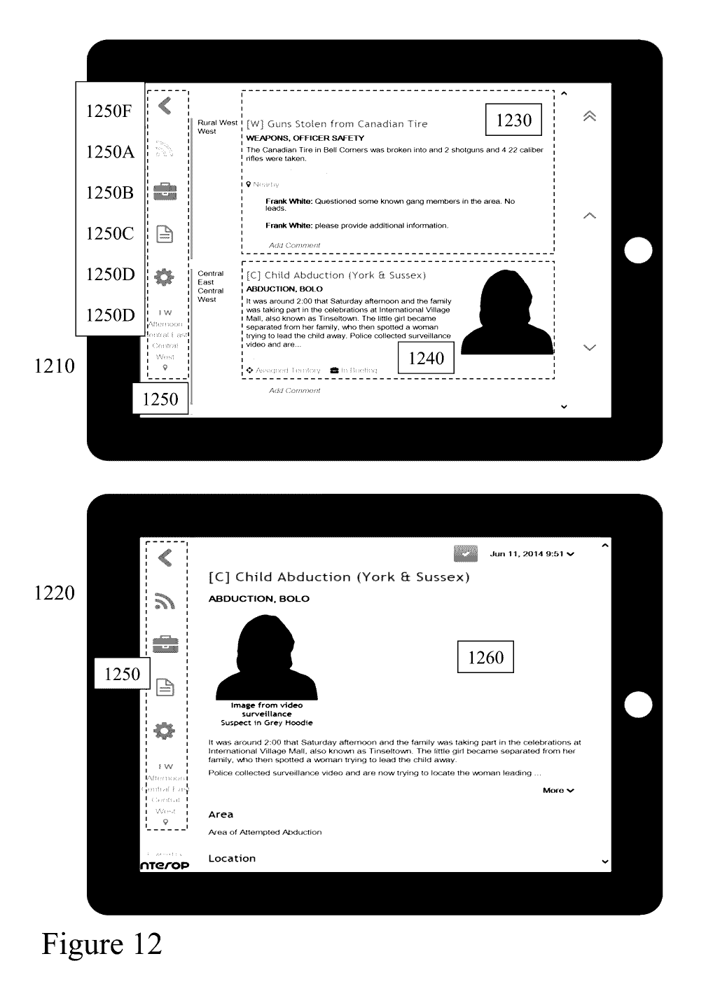

Briefings within the LESLEAP support the concept of states which provide a clear understanding of where the briefing is in its life cycle. The state would influence when the officers included in the briefing have access to its contents and when information can be added, removed, or updated. For example, the LESLEAP may support the following states:
Draft—Initial stage of a newly created briefing, only visible to creators or delegators
Published/Active—Visible to all participates and delegators and available during the entire shift for collaboration
Archived—Searchable and retrievable but removed from general visibility and can no longer be edited or modified. Archiving may be automatic after fixed period of time as priority items not addressed will automatically appear in the next briefing and/or officer content.

Where items in the briefing are high priority to specific attendees at the briefing then they will find these items are within their personal prioritized list of items/tasks. Examples of such personal prioritized list of items/tasks are depicted in FIG. 12 with first and second exemplary user interfaces 1210 and 1220 upon a law enforcement officer's portable electronic device as provided by a LESLEAP supporting embodiments of the invention. In each instance the user has access to a menu bar 1250 which incorporates buttons 1250A to 1250E relating to pulling an updated feed of prioritized information, accessing a briefing presented prior to the shift, accessing a case, accessing a report to review or prepare, accessing tools, or re-accessing their briefing as well as a back button 1250F relating to navigating where the user has selected an item in the feed to view thereby triggering second exemplary user interface 1220 wherein the menu 1250 is maintained but rather than multiple items of their feed they are presented with the details of an item. These features for some users may be locked to read only whilst others may have read/write access. Some aspects, such as accessing a case, may adjust the context of the user automatically or based upon the user's action when accessing the case.

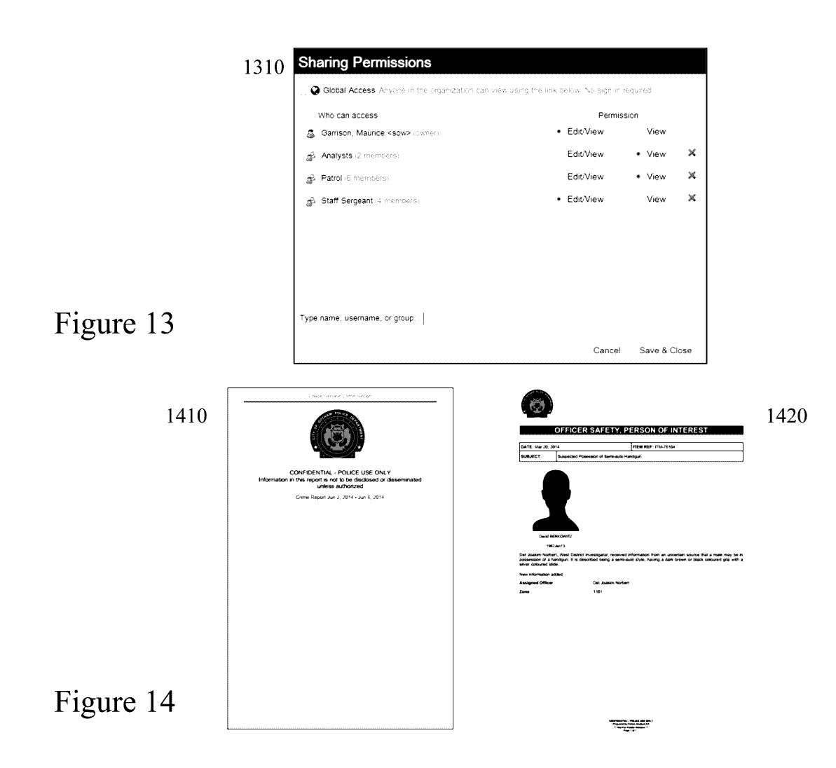

Referring to FIG. 13 there is depicted an exemplary permissions interface for a LESLEAP supporting embodiments of the invention. Accordingly, a permission may be established to a briefing, case, item, event, report, etc. As noted a global access can be enabled or alternatively specific individuals or groups may be granted permission(s). For example, a user may be granted view permission only or given edit/view permissions. As depicted in FIG. 13 “Maurice Garrison” as owner of the item and Staff Sergeants are given edit/view permissions but analysts and patrol are only able to view. Optionally, specific patrol officer(s) and/or analyst(s) may be added to edit/view. Other users, groups etc. can be added as appropriate to the item.

As discussed supra a LESLEAP supporting embodiments of the invention may generate standardized reports as depicted in FIG. 14 with first and second reports 1410 and 1420 respectively. First report 1410 may be employed to provide information to the general public in respect of seeking help with a crime, missing person, etc. Second report 1420 may be employed to provide information to others within the organization, e.g. an FYI, safety bulletin, person of interest etc. As depicted in FIG. 6 the content of these may be automatically extracted and prepared against different templates according to target audience by an organization.

Accordingly, it would be evident that front line officers on the move can be provided with a consolidated context-aware tactical information feed that is relevant to their current situation for both reactive and proactive decision-making. This includes situational awareness and actionable priorities prioritized by location, staleness, assigned zone, current zone, prioritized content via current shift briefing, and prioritized content via current district/divisional analyst report etc. Accordingly, the TAMOF 470/Tactical Mobility 580 informs decision-making at street-level and is available on existing organizational mobile data terminals as well as other devices such as PEDs and FEDs. Accordingly, as an officer responds to calls for service, the TAMOF 470/Tactical Mobility 580 automatically transitions from a distributive pull based feed to a reactive feed containing only relevant information such as officer safety issues, intelligence products, warrants etc. useful for the current call. After the call is cleared the officer's feed will transition back to a distributive feed.

Within embodiments of the invention the LESLEAP may include external news feed support which is similarly subjected to processing through the RELENG 410/550 based upon processing of the news feed yielding tagged segments that are then similarly processed as other data within the LESLEAP to provide news feed segments based upon the same contextual awareness rules as the remainder of their feed. Similarly, content extracted from a SOME and/or SOCNET may be similarly filtered, tagged, and delivered via the RELENG 410/550. In other embodiments of the invention the LESLEAP may include, in association with a person of interest, identification of one or more SOMEs/SOCNETs associated with the person of interest such that an officer when wishing to establish potential whereabouts in respect of the person of interest may view these one or more SOMEs/SOCNETs to identify information of interest. Alternatively, the LESLEAP may provide within a person of interest page a consolidated SOCNET/SOME feed for the person of interest.

In a similar manner, notifications as depicted in respect of FIGS. 7 through 14 may include identification of a briefing and/or a case file which if selected provides, according to access privileges, access to the case file for additional information etc. Accordingly, the officer may access additional information or add through such file access additional information/reports etc. Alternatively, they may through the case access button 1250B of menu 1250 in FIG. 12 similarly access cases on which they are assigned or through a search engine access a historical case etc. Alternatively, the user may be unable to search or access through the Tactical Interface such that the user is kept focused to the things that are relevant to their shift, context, location, etc. Any item of content provided to an officer through the RELENG 410/550 may have associated with it other files, video files, audio files, text documents, photographs etc. In some instances, these may form part of a briefing but are not part of the default prioritized feed due to the display/format constraints and accordingly are accessed through links. For example, the availability of specific additional content is identified through one or more icons as known within the prior art.

Within a LESLEAP according to embodiments of the invention the concept of Information Lifecycle Management is important so that the prioritized information to the officer/analyst etc. is relevant and time limited. Accordingly, items can be published for defined periods of time before automatic archiving which reduces information overload. Expiring items are simply updated to an archived status upon expiry. As such items such as FYIs, BOLOs etc. that have no action or actions to define them as closed are removed automatically unless having previously received an in-application notification, e.g. provided to analysts, investigators and other information creators/owners, that an items is expiring the item is republished for a longer period of time before auto archiving. Accordingly, a task to an officer such as “Take Statement—Eye Witness” is automatically removed when the officer submits their report but maintains high priority unless other events/activities lower the priority of this item.

LESLEAPs according to embodiments of the invention also support searching to provide users with a single line searching experience that uses wildcard, exact phrase, and fuzzy search methods. Word matches in the results are highlighted which is useful when fuzzy search is being used. In addition to word search, the results can also be filtered based on the content of the item or report using location, time, or user activity etc. or overlap to a current item/task for the officer.

As indicated by FIG. 13 a LESLEAP supports access control mechanisms that provide secure sharing of information such as Items, Reports, and Briefings at various levels. This provides granular control over sensitive information. Accordingly, Items, Reports and Briefings can be shared at the following levels:
Global—sharing with everyone (Anonymous Access)
Domain—sharing with specific organizations (Domains—multi-tenanted mode)
Group—sharing with specific Groups
User—sharing with specific Users

Such sharing permissions may be a combination of the above levels for each Item, Report, and Briefing. Typically, information may be shared with either an Edit and/or View permission. Edit permission allows for updates by the user whilst View permission allows content to be simply viewed. Within some groups a third permission may be provided relating to an Add permission allowing a permitted user to add a new task/item. Such Add permission may for example be provided to emergency call centre operators, e.g. 911 operators, specific analysts, detectives, and other ranks globally or by specific individual/role.

Non-sensitive information can be shared globally with non-authenticated or non-licensed Users. This enables information sharing with the entire organization (Domain) up front. Information that is sensitive in nature can only be shared with authenticated or licensed Users. Alternatively, when deployed in multi-tenanted mode, Items, Reports and Briefings can be shared across organizations (Domains) at multiple levels of granularity. Such sharing rules may be automated based upon events such as creation allowing Standard Operating Procedures (SOPs) to be implemented that enforce sharing of information upon creation at various level of security.

LESLEAPs according to embodiments of the invention may support role-based authorization systems wherein Roles can be directly associated to Users and control core functionality such as they creation of Items, Reports and Briefings. User authentication may vary from basic authentication through username and password as managed within the LESLEAP whilst in other instances a Single-Sign-On (SSO) Authentication may be employed, such as Kerberos authentication, for example, via centralized Identity Management systems (IdMs).

Within the embodiments of the invention presented supra in respect of FIGS. 4 to 14 is the RELENG, for example RELENG 410 in FIG. 4 or RELENG 550 in FIG. 5. The RELENG transforms the platform into a context-aware solution that increases efficiency and effectiveness, informs tactical, street-level decision-making, and increases situational awareness. In order to achieve this several key elements are providing including:
Dynamic Datastore—A dynamic datastore is used to effectively structure various types of information including patterns/trends, BOLOs, FYIs, bulletins, warrants, conditions, people, vehicles etc. It is geospatially (location) enabled allowing for complex location queries to be performed;
Fast Search Index—A high performance and scalable search index is used for searching and filtering massive amounts of information prior to ranking. The index is automatically synchronized with the datastore in real-time; and
Ranking Algorithm—The RELENG uses a propriety algorithm and method to rank and prioritize results returned by the search index. The engine enables the prioritization of information at shift briefing and at street-level for front line officers. Several complex ranking features are configured based on direct operational standard operating procedures. As noted supra the RELENG generates shift briefings on-demand by searching for content that is relevant to the chosen area of responsibility (division or district) and shift. This ensures actionable priorities and situational awareness is delivered synchronously on time. Supervising officers can then augment the briefing and decide what is important and what should be prioritized for the current shift.

Key ranking features for briefings include, but are not limited to:
Description—Operational Significance;
In Report—Items prioritized by analysts within weekly/bi-weekly divisional/district crime reports with strong suggestion for action by district analysts;
Nearby Items—Items intersecting the briefing area of responsibility;
Actionable Items—Information that enhances immediate situational awareness; and
Safety Items—Information relating to officer safety.

The RELENG prioritizes actionable priorities and situational awareness for the tactical front line feed by searching for information that is currently relevant to the front line officer in both reactive and proactive situations. The engine relies on key aspects of an officer's context such as location, zone assignment etc. to prioritized information automatically. Most important, the direction provided by analysts via divisional/district crime reports and supervising officers via shift briefs are a key input into what is prioritized for front line officers and communicated to them via the Tactical Mobility module, e.g. TAMOF 470 or Tactical Mobility 580.

Key ranking features for street-level ranking include, but are not limited to:
In Report—Items prioritized by analysts within weekly/bi-weekly divisional/district crime reports, e.g. items with strong suggestion for action by district analysts;
In Briefing—Items prioritized by supervising officers within daily shift briefings, e.g. items with directed priority or relevant information by supervising officer based on area of responsibility;
Nearby Items—Items within a predetermined range, e.g. 500 m, of the officer's current location, e.g. actionable information or information that enhances immediate situational awareness based on current location;
Current Zone—Items within the current zone of the front line officer, e.g. actionable information or information that enhances immediate situational awareness for officers on the move;
Assigned Zone—Items within the assigned zone of the front line officer, e.g. actionable information or information that enhances immediate situational awareness based on zone assignment;
Staleness—Active items recently created, updated based on the current date/time, e.g. strong signal for new or trending information which includes a time decay as information decreases in relevance over time;
Safety Tags;
Assigned User; and
Actionable—Safety Items—Items created or updated since the briefing was presented.

With respect to officers searching for items etc. within the LESLEAP then multiple capabilities may be supported including, for example:
Single Line Searching: The system should allow a simple single line search to provide an easy to use interface for searching the system.
Advanced Searching: Advanced searching to include/exclude additional parameters for the search. The user should be able to include various information sources and include dates and times as possible ways to limit the results.
Persistent Search/Search Alerts: Persistent Search should be supported for a configurable period of time. A persistent search will be automatically run by the system at a configurable interval. If the result set changes the user will be made aware and the information will be pushed to them.
Search Awareness: Search awareness is the ability to see if a similar search has been performed and then provide information on who performed that search. The system can also support the ability to covertly search. In most cases this would be senior officers being able to see what other officers are searching for.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
establishing an identity of a user scheduled to perform a role within a structured organization for a session, the user s identity, role and session information being stored within a schedule upon a server accessible to the structured organization via a first network;
establishing a first context of the user with respect to their responsibilities within the structured organization for the role scheduled;
establishing a second context of the user with respect to their activities associated with the scheduled session;
establishing a third context of the user with respect to their identity;
establishing a fourth context of the user with respect to capabilities of at least an electronic device of a plurality of electronic devices associated with their role and the structured organization;
retrieving content from at least a database of a plurality of databases accessible to the structured organization via the first network;
compiling and formatting the retrieved content in dependence upon the electronic device of the plurality of electronic devices; and
transmitting the compiled and formatted retrieved content to the electronic device of the plurality of electronic devices via a second network.

2. The method according to claim 1, wherein
the compiled and formatted retrieved content is a briefing for presentation to a predetermined subset of the members of a structured organization, and
the compiled and formatted retrieved content as further generated in dependence upon contextual information relating to the predetermined subset of the members of a structured organization.

3. The method according to claim 1, further comprising
automatically retrieving, compiling and formatting new content based upon establishing that the current context of the user with respect to the activities and responsibilities of the structured organization has changed such that the new content should be provided to the user.

4. The method according to claim 1, further comprising
automatically retrieving, compiling and formatting new content based upon establishing that the current context of the user with respect to the activities and responsibilities of the structured organization should change such that the new content should be provided to the user, wherein
the need for change being established in dependence upon a variation within remotely stored data used to generate the content provided to the user based upon a current context.

5. A relevance engine connected to a globally distributed network for managing content provided to a user, who is a member of a structured organization, in dependence upon the context of the user with respect to the activities and responsibilities of the structured organization, wherein
the relevance engine via the globally distributed network is connected to at least one of:
a mobile module providing the managed content to the user;
a geointelligence module accessing stored items and reports relating to items in conjunction with attributes associated with the items and reports relating to items;
third party databases storing information relating to physical assets and/or individuals; and
a geobriefing module for generating a briefing for presentation to a predetermined subset of the members of a structured organization which was generated automatically based upon contextual information relating to the predetermined subset of the members of a structured organization.

6. The relevance engine according to claim 5, wherein
the relevance engine via the globally distributed network is connected to at least one of:
a record management system comprising a plurality of remotely stored databases;
a computer aided dispatch system relating to allocating members of the structured organization in response to newly established activities and/or priorities; and
social media and/or social media networks.
